(19) United States
(12) Patent Application Publication
(10) Pub. No.: US 2019/0114582 A1
(43) Pub. Date: Apr. 18, 2019

(54) DELIVERY MANAGEMENT SYSTEM AND METHOD FOR OUTPUTTING LOCATION AND ENVIRONMENTAL INFORMATION

(71) Applicant: TOSHIBA TEC KABUSHIKI KAISHA, Tokyo (JP)

(72) Inventor: Hiroshi NISHIKAWA, Izunokuni Shizuoka (JP)

(21) Appl. No.: 16/157,548

(22) Filed: Oct. 11, 2018

(30) Foreign Application Priority Data
Oct. 13, 2017 (JP) 2017-199514

(51) Int. Cl. G06Q 10/08

(52) U.S. Cl. CPC G06Q 10/0832; G06Q 10/0833

(57) ABSTRACT

A delivery management system according to an embodiment includes at least one server. The server receives a retrieval request including a commodity code. The server acquires, for each commodity that corresponds to the commodity code: first information including location status information of the commodity detected by a first terminal and location information of the first terminal, and second information including environmental information at a storage location and location information of a second terminal. The server outputs display information to display a list of each commodity. The server receives a selection of one of the commodities, and outputs delivery route information of the selected commodity based on the first information. The server receives a second selection of a portion of the delivery route, and outputs environmental information to display the at least one environmental condition corresponding to the selected portion of the delivery route based on the second information.

### CROSS-REFERENCE TO RELATED APPLICATION

This application is based upon and claims the benefit of priority from Japanese Patent Application No. 2017-199514, filed on Oct. 13, 2017, the entire contents of which are incorporated herein by reference.

### FIELD

Embodiments described herein relate generally to a delivery management system and a method for outputting location and environmental information.

### BACKGROUND

A system known as an EPCIS (EPC Information Service) or the like is used to store information indicating when, where, what type of a commodity, in what state, or the like on a computer such that a user can browse a history relating to the delivery of an article such as a commodity.

On the other hand, at the time of transporting commodities (such as perishable commodities) required to be fresh, such as fresh food such as fruits and vegetables, fresh fish or meat, fresh flowers or the like, measures are taken to transport them while maintaining freshness. However, the freshness may decrease due to storage in warehouses or during transportation by vehicles. Therefore, there is already known a system for collecting environmental information such as temperature and humidity during storage or transportation and allowing a user to browse the environmental information.

### DESCRIPTION OF THE DRAWINGS

FIG. 1 is a schematic diagram illustrating a configuration of a delivery management system including a delivery management apparatus;

FIG. 2 is a schematic diagram illustrating a configuration of a first terminal;

FIG. 3 is a schematic diagram illustrating a configuration of a second terminal;

FIG. 4 is a diagram illustrating a circuit configuration of a first server;

FIG. 5 is a schematic diagram illustrating a master file stored in an auxiliary storage device of the first server;

FIG. 6 is a schematic diagram illustrating a data record stored in a tracking repository;

FIG. 7 is a schematic diagram illustrating a data record stored in an environmental repository;

FIG. 8 is a schematic diagram illustrating a conversion table;

FIG. 9 is a schematic diagram illustrating integrated data stored in an integrated file;

FIGS. 10-12 are flowcharts depicting procedures of a main information processing executed by a processor of the first server; and

FIG. 13 illustrates an example of a delivery monitoring screen displayed on a display device of a user terminal.

### DETAILED DESCRIPTION

A delivery management system according to an embodiment includes a first terminal, a second terminal, and at least one server. The server is programmed to receive from a user device a retrieval request including: a commodity code corresponding to commodities subject to a delivery process, and a retrieval condition. Based on the retrieval request, the server acquires, for each individual commodity that corresponds to the commodity code included in the retrieval request and whose status in the delivery process correspond to the retrieval condition: first information including, in correspondence, location status information indicating a delivery status of the individual commodity detected by the first terminal, and first location information corresponding to a location of the first terminal, and second information, including, in correspondence, environmental information indicating at least one environmental condition detected by the second terminal at a storage location of the individual commodity, and second location information corresponding to a location of the second terminal. The server generates and outputs to the user device display information for causing the user device to display a list of each individual commodity that corresponds to the commodity code included in the retrieval request and whose status in the delivery process correspond to the retrieval condition. The server receives from the user device a first selection of one of the individual commodities displayed on the list, and in response, generates and outputs to the user device delivery route information causing the user device to display a delivery route map indicating a delivery route of the selected individual commodity based on the first information. The server further receives from the user device a second selection of a portion of the delivery route, and in response, generates and outputs to the user device environmental information causing the user device to display the at least one environmental condition at a location corresponding to the selected portion of the delivery route based on the second information.

Hereinafter, an embodiment of a delivery management apparatus, which can integrate a delivery history of an article with the environment in which the article being delivered is located and can allow a user to browse that information, is described with reference to the accompanying drawings. The present embodiment illustrates a case of applying the delivery management apparatus to a physical distribution system for delivering fresh commodities which are an example of the article. The fresh commodities are, for example, fresh food (i.e., fruits and vegetables, fresh fish or meat), or fresh flowers from manufacturers. The fresh commodities are delivered via a distribution center to a store.

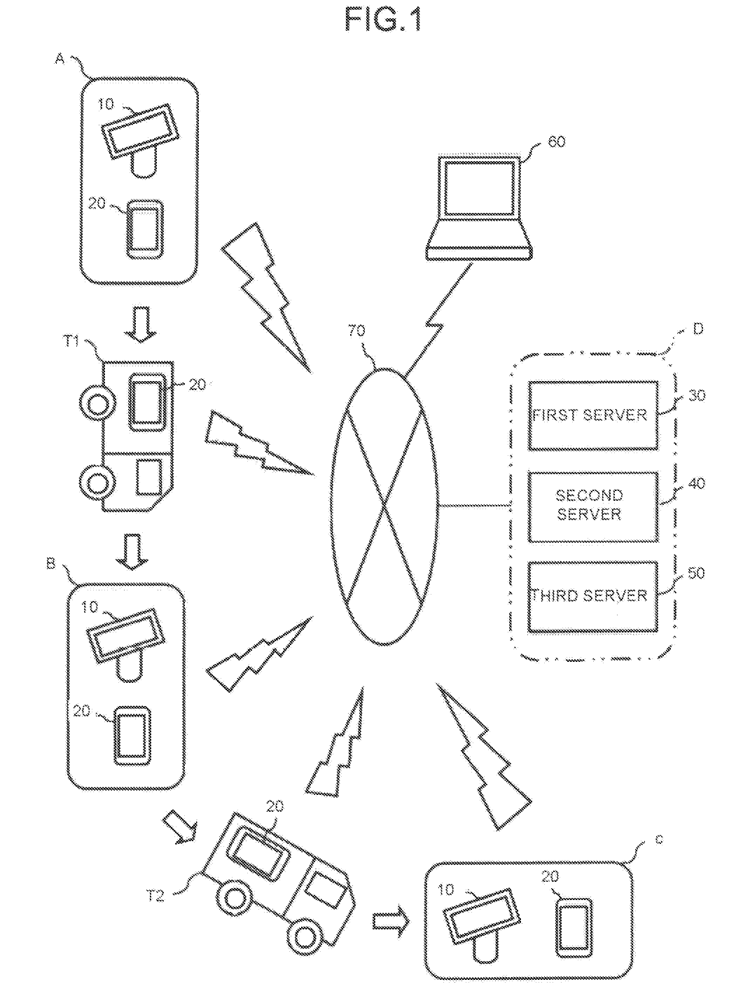

FIG. 1 is a schematic diagram illustrating a physical distribution system and a delivery management system including a delivery management apparatus. The physical distribution system includes a first delivery step and a second delivery step. The first delivery step is placing a fresh commodity (hereinafter, simply referred to as a commodity) manufactured by a manufacturer A on a transport device T1 such as a vehicle and delivering it to a distribution center B. The second delivery step is placing the commodity collected in the distribution center B on a transport device T2 such as a vehicle and delivering it to a store C. There may be a plurality of manufacturers A and stores C, but only one manufacturer A and one store C are shown in FIG. 1, representatively.

The delivery management system includes a first terminal 10, a second terminal 20, a first server 30, a second server 40, a third server 50, a user terminal 60, and a network 70. The first terminal 10 is provided at each of the manufacturer A, the distribution center B, and the store C, respectively. The second terminal 20 is provided in each of the manufacturer A, the distribution center B and the store C and each of the transport devices T1 and T2, respectively. The first server 30, the second server 40, and the third server 50 are server devices on a cloud D. The user terminal 60 includes an input device and a display device. For example, the user terminal 60 may be a personal computer, a tablet terminal, or the like. The network 70 connects the first terminal 10, the second terminal 20, and the user terminal 60 to the first server 30, the second server 40, and the third server 50 in a wired or wireless manner. For example, the network 70 may be the Internet.

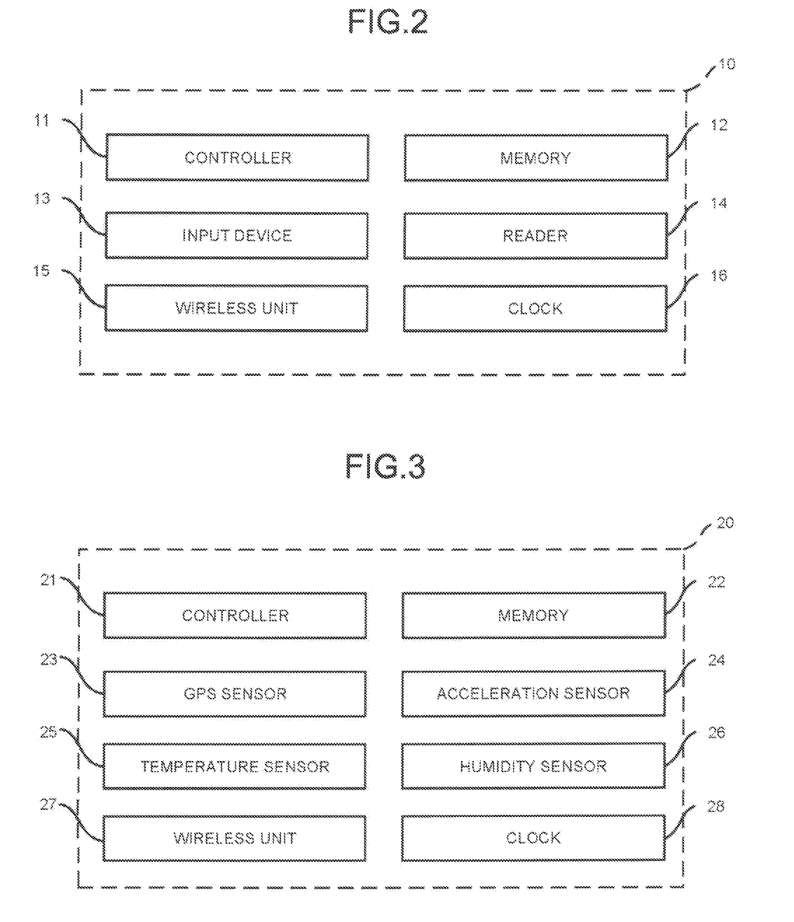

FIG. 2 is a schematic diagram illustrating an internal configuration of the first terminal 10. The first terminal 10 includes a controller 11, a memory 12, an input device 13, a reader 14, a wireless unit 15, and a clock 16. The controller 11 controls the operation of the first terminal 10. The memory 12 stores various data. The input device 13 is a keyboard, a touch panel, or the like. The reader 14 reads data stored in an RFID (Radio Frequency Identification) tag in a non-contact manner. The wireless unit 15 transmits and receives data wirelessly to and from an access point of the network 70. The clock 16 tracks a current date and time.

The first terminal 10 stores a unique terminal ID thereof in the memory 12. Hereinafter, the terminal ID of the first terminal 10 is referred to as a terminal 1 ID. The first terminal 10 has a first mode and a second mode. The switching between the first mode and the second mode is performed via the input device 13.

In the present embodiment, RFID tags having different identification numbers are attached to individual commodities manufactured by the manufacturer A. An IC memory of the RFID tag stores at least a commodity code for identifying the commodity attached with the RFID tag together with the identification number.

If the data (commodity code, identification number, etc.) of the RFID tag attached to the commodity is read by the reader 14 in the state in which the first mode or the second mode is selected, the controller 11 wirelessly transmits a data signal including the date and time, the terminal 1 ID, the commodity code, the identification number, and a mode flag via the wireless unit 15. The date and time refers to the date and the time measured by the clock 16 when the RFID tag is read. The terminal 1 ID is stored in the memory 12. The commodity code and the identification number are read by the reader 14 from the RFID tag. The mode flag is used for identifying whether the first mode or the second mode is selected. The data signal wirelessly transmitted from the first terminal 10 is transmitted to the second server 40 via the network 70.

As such a type of first terminal 10, an existing RFID reader, an RFID reader/writer, or the like can be applied.

FIG. 3 is a schematic diagram illustrating an internal configuration of the second terminal 20. The second terminal 20 includes a controller 21, a memory 22, a GPS (Global Positioning System) sensor 23, an acceleration sensor 24, a temperature sensor 25, a humidity sensor 26, a wireless unit 27, and a clock 28. The controller 21 controls the operation of the second terminal 20. The memory 22 stores various data. The GPS sensor 23 uses a GPS (Global Positioning System) to measure the current position (latitude and longitude) of the second terminal 20. The acceleration sensor 24 detects an acceleration generated due to the movement of the second terminal 20. The temperature sensor 25 detects a temperature of the environment in which the second terminal 20 is located. The humidity sensor 26 detects humidity of the environment in which the second terminal 20 is located. The wireless unit 27 wirelessly transmits and receives data to and from the access point of the network 70. The clock 28 tracks the current date and time.

The second terminal 20 stores a unique terminal ID thereof in the memory 22. Hereinafter, the terminal ID of the second terminal 20 is referred to as a terminal 2 ID.

The controller 21 wirelessly transmits the data signal including the date and time, the terminal 2 ID, and sensing data via the wireless unit 27 each time a preset period elapses. The date and time are the date and the time measured by the clock 28 when the period of time has elapsed. The terminal 2 ID is stored in the memory 22. The sensing data includes values detected by various sensors such as the GPS sensor 23, the acceleration sensor 24, the temperature sensor 25, and the humidity sensor 26 when the period of time elapses. The data signal wirelessly transmitted from the second terminal 20 is transmitted to the third server 50 via the network 70.

As such the second terminal 20, an existing smartphone or the like can be used.

The types of sensors provided in the second terminal 20 are not limited to those described above. The second terminal 20 may be provided with less than all of the above sensors, or may be provided with another sensor.

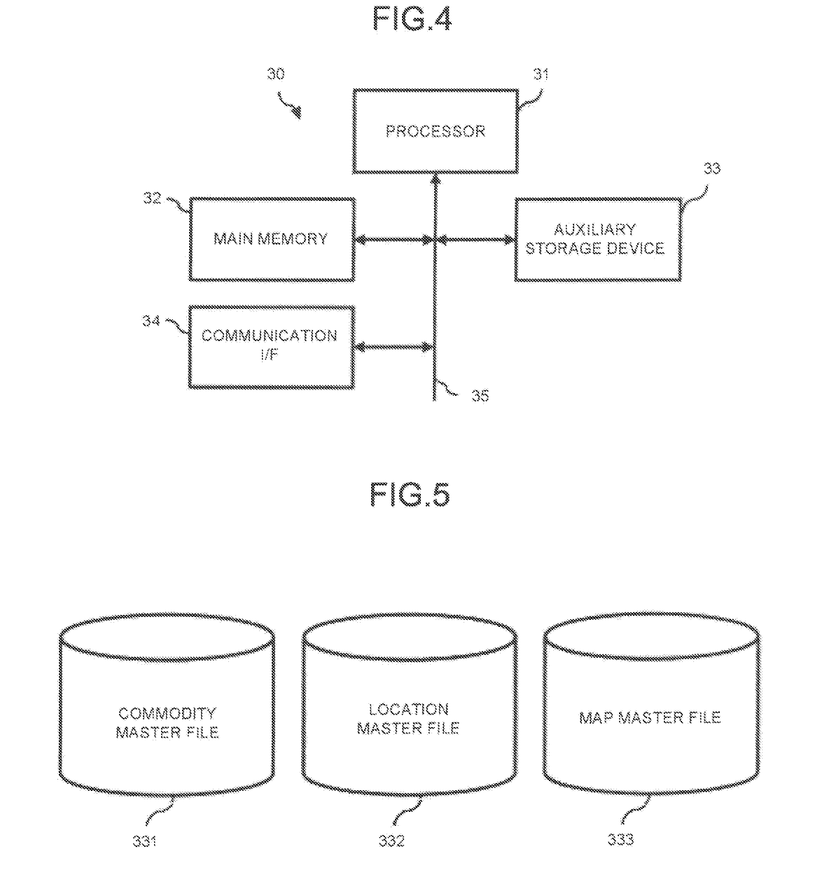

FIG. 4 is a block diagram illustrating a circuit configuration of main portions of the first server 30. The second server 40 and the third server 50 have the same circuit configurations as the first server 30. Therefore, here, only the circuit configuration of the first server 30 is described, and the description of the circuit configurations of the second server 40 and the third server 50 is omitted.

The first server 30 includes a processor 31, a main memory 32, an auxiliary storage device 33, a communication interface 34, and a system bus 35. The processor 31, the main memory 32, the auxiliary storage device 33 and the communication interface 34 in the first server 30 are connected to the system bus 35. The processor 31, the main memory 32, the auxiliary storage device 33 and the communication interface 34, and the system bus 35 in the first server 30 function as a computer.

The processor 31 acts as a central controller of the computer. The processor 31 controls each section to realize various functions of the first server 30 by executing operating systems and application programs.

The main memory 32 acts as a main storage section of the computer. The main memory 32 includes a non-volatile memory area and a volatile memory area. The main memory 32 stores the operating systems and the application programs in the non-volatile memory area. The main memory 32 stores data necessary for the processor 31 to execute a processing for controlling each section in the non-volatile or volatile memory area in some cases. The main memory 32 uses the volatile memory area as a work area where data is appropriately rewritten by the processor 31.

The auxiliary storage device 33 acts as an auxiliary storage section of the computer. The auxiliary storage device 33 is, for example, an EEPROM (Electric Erasable Programmable Read-Only Memory), a HDD (Hard Disk Drive), a SSD (Solid State Drive), or the like. The auxiliary storage device 33 stores data used for the processor 31 to execute various processing and data generated in the processing by the processor 31. The auxiliary storage device 33 stores the above application programs in some cases.

The communication interface 34 acts as an input/output section of the computer. The communication interface 34 transmits or receives data according to a predetermined communication protocol with devices connected via the network 70. The devices include the first terminal 10, the second terminal 20, and the user terminal 60. The communication interface 34 also transmits and receives data to and from other servers (the second server 40 and the third server 50) on the cloud D.

FIG. 5 is a schematic diagram illustrating a master file stored in the auxiliary storage device 33 of the first server 30. The first server 30 allocates a part of the storage area of the auxiliary storage device 33 as a commodity master file 331, a location master file 332, and a map master file 333.

The commodity master file 331 stores information relating to a commodity whose delivery status is managed by the delivery management system of the present embodiment. The information includes at least a commodity code, a commodity name and a commodity image. In the physical distribution system, the location master file 332 stores information relating to locations where the delivered commodity is temporarily placed, for example, information relating to each of the manufacturer A, the distribution center B, and the store C, and information relating to the transport device T1 and T2. The information includes at least a location ID and a location name. The location ID is a unique code individually assigned to each location and each of the transport means T1 and T2. The map master file 333 stores a road map data of an area where each location is located.

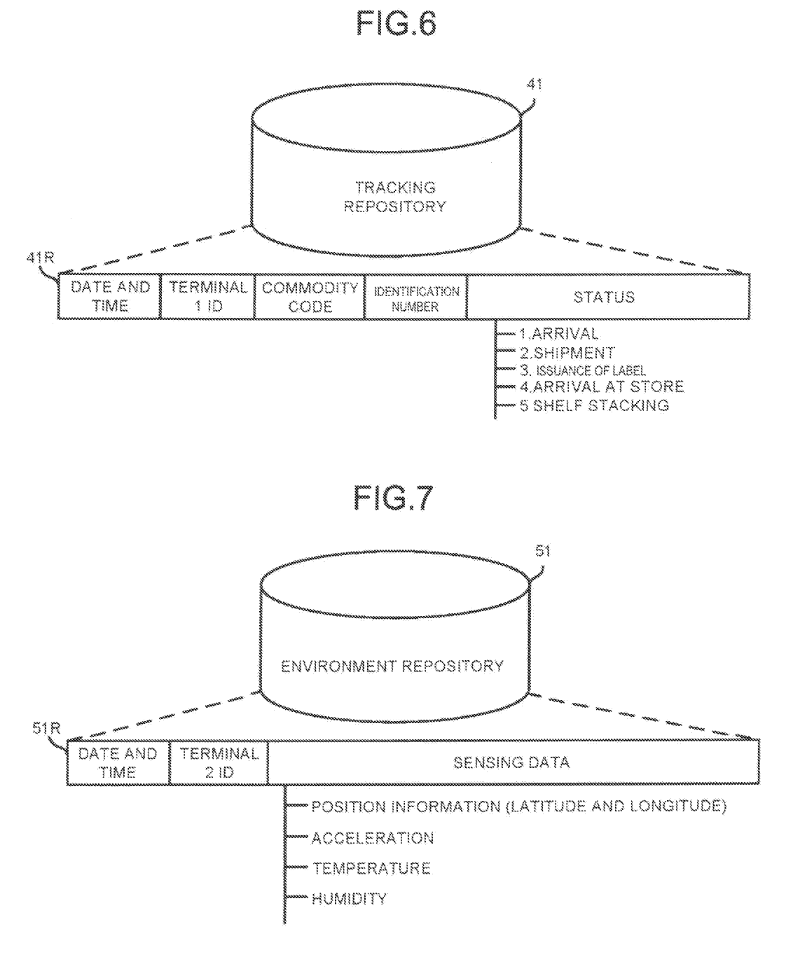

FIG. 6 is a schematic diagram illustrating a data record 41R stored in a tracking repository 41. The tracking repository 41 is formed in an auxiliary storage device of the second server 40.

The data record 41R includes at least the date and time, the terminal 1 ID, the commodity code, the identification number and the status. The date and time, the terminal 1 ID, the commodity code and the identification number are contained in the data signal transmitted from the first terminal 10. The status is determined by the mode flag contained in the data signal and the terminal 1 ID. Specifically, when the terminal 1 ID is an ID of the first terminal 10 located in the manufacturer A and the mode flag indicates the first mode, the status is “3: issuance of label.” When the terminal 1 ID is the ID of the first terminal 10 located in the manufacturer A and the mode flag indicates the second mode, the status is “2: shipment.” When the terminal 1 ID is the ID of the first terminal 10 located in the distribution center B and the mode flag indicates the first mode, the status is “1: arrival.” When the terminal 1 ID is the ID of the first terminal 10 located in the distribution center B and the mode flag indicates the second mode, the status is “2: shipment.” When the terminal 1 ID is the ID of the first terminal 10 located in the store C and the mode flag indicates the first mode, the status is “4: arrival at store.” When the terminal 1 ID is the ID of the first terminal 10 located in the store C and the mode flag indicates the second mode, the status is “5: shelf stacking.” The status is not limited to the above examples and may be arbitrary.

FIG. 7 is a schematic diagram illustrating a data record 51R stored in an environment repository 51. The environment repository 51 is formed in the auxiliary storage device of the third server 50.

The data record 51R includes at least the date and time, the terminal 2 ID, and sensing data. The date and time, the terminal 2 ID, and the sensing data are contained in the data signal transmitted from the second terminal 20.

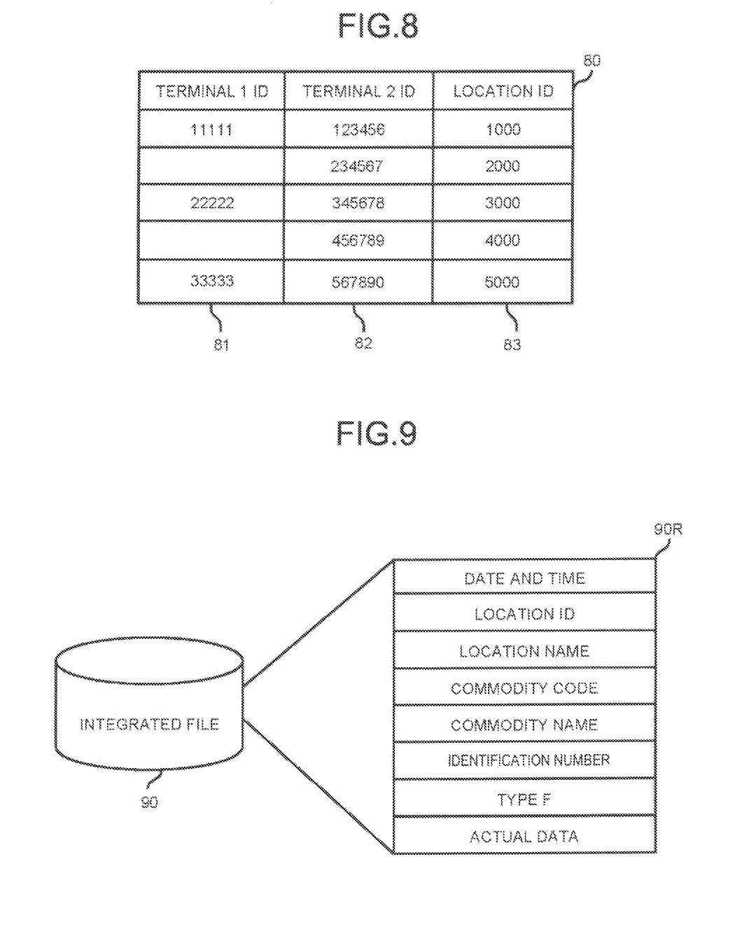

FIG. 8 is a schematic diagram illustrating a conversion table 80. The conversion table 80 is stored in the main memory 32 or the auxiliary storage device 33 of the first server 30.

The conversion table 80 includes a field 81 indicating the terminal 1 ID, a field 82 indicating the terminal 2 ID, and a field 83 indicating the location ID. In the field 81 indicating the terminal 1 ID, the terminal IDs of the first terminals 10 located in the each of the manufacturer A, the distribution center B and the store C are stored. In the field 82 indicating the terminal 2 ID, the terminal IDs of the second terminals 20 located in each of the manufacturer A, the distribution center B and the store C and each of the transport devices T1 and T2 are stored. Then, in association with the terminal ID of the first terminal 10 and the terminal ID of the second terminal 20 which are provided in the same location, the location ID assigned to each location is stored in the field 83. In association with the terminal ID of the second terminal 20 provided in each of the transport devices T1 and T2, the location ID assigned to the transport device T1 or the transport device T2 is stored in the field 83.

FIG. 9 is a schematic diagram illustrating an integrated data 90R stored in an integrated file 90. The first server 30 allocates a part of the storage area of the main memory 32 or the auxiliary storage device 33 as the integrated file 90.

The integrated data 90R is composed of at least the date and time, the location ID, the location name, the commodity code, the commodity name, the identification number, a type flag and actual data. The type flag identifies the type of the integrated data 90R. The integrated data 90R includes first integrated data 90R1 generated from the data record 41R detected from the tracking repository 41 and second integrated data 90R2 generated from the data record 51R detected from the environment repository 51. The first integrated data 90R1 includes all items including the date and time, the location ID, the location name, the commodity code, the commodity name, the identification number, the type flag and the actual data. The second integrated data 90R2 includes the date and time, the location ID, the location name, the type flag and the actual data. The commodity code, the commodity name and the identification number are excluded. The type flag is in the case of the first integrated data 90R1, and is “1” in the case of the second integrated data 90R2. The actual data is the status in the case of the first integrated data 90R1, and is the sensing data in the case of the second integrated data 90R2.

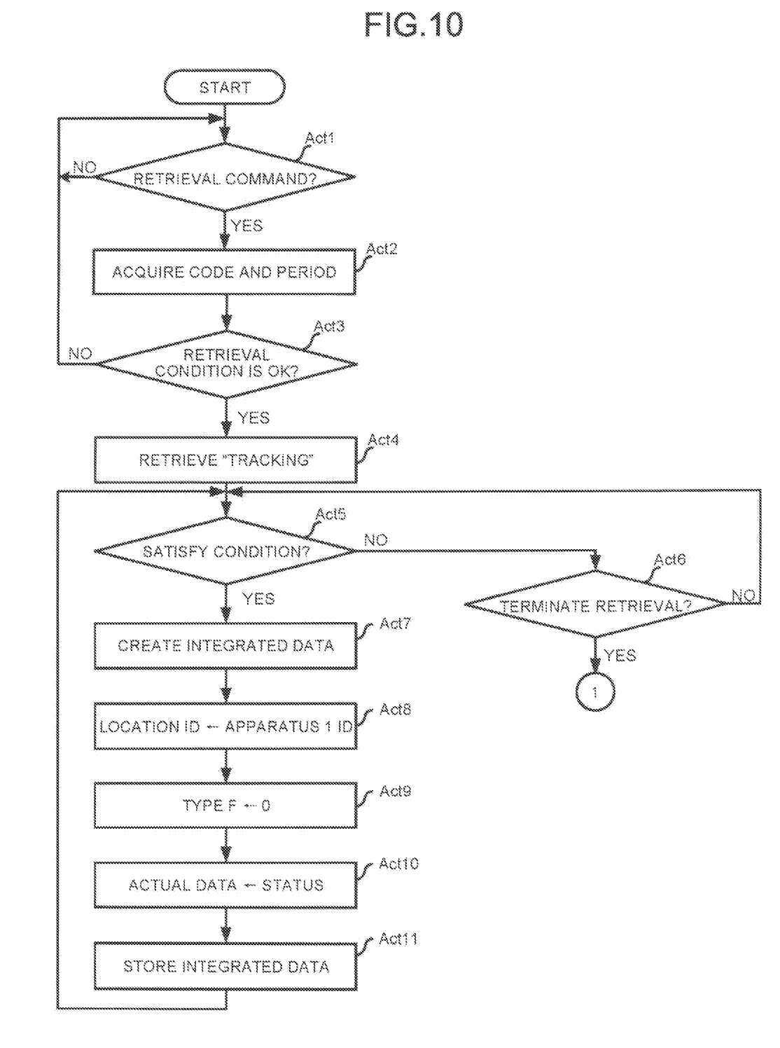

In the delivery management system of such a configuration, the first server 30 functions as the delivery management apparatus of the present embodiment. Main operations of the first server 30 are described below with reference to FIG. 10 to FIG. 13.

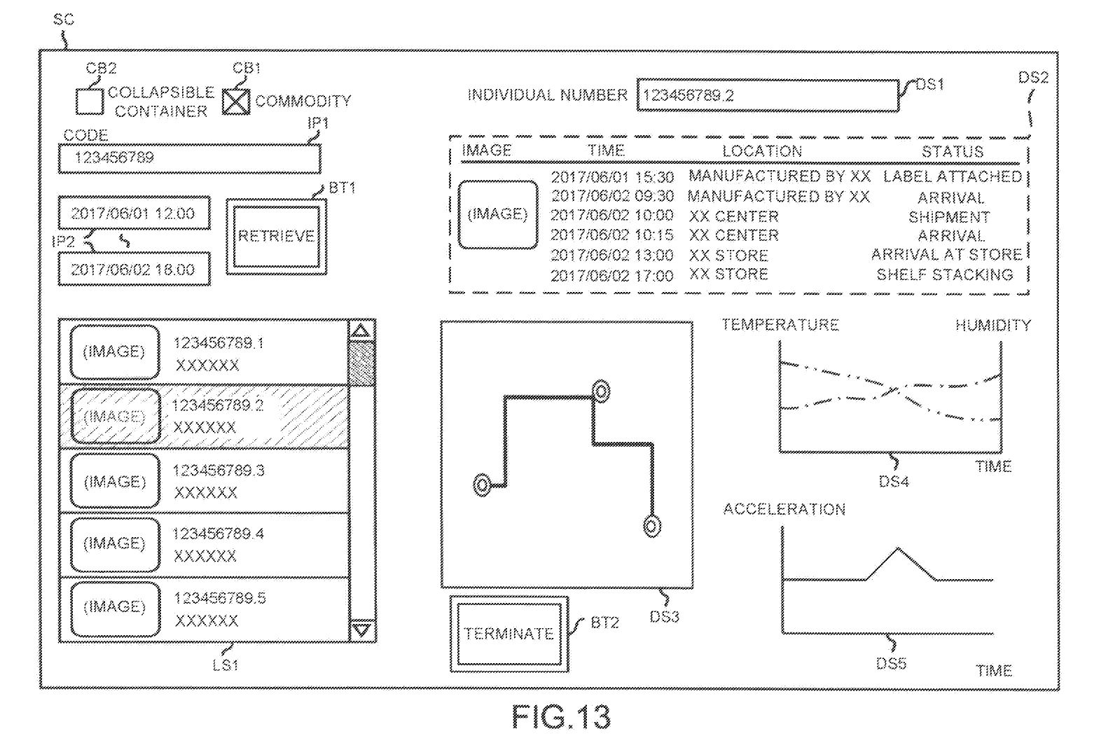

FIG. 10 to are flowcharts depicting procedures of a main information processing executed by the processor 31 of the first server 30 through executing a predetermined program. The program is an application programs stored in the main memory 32 or the auxiliary storage device 33. FIG. 13 shows an example of a delivery monitoring screen SC displayed on the display device of the user terminal 60 by the information processing. First, the configuration of the delivery monitoring screen SC is described. The configuration of the delivery monitoring screen SC is not limited to the one described below.

The delivery monitoring screen SC includes two check boxes CB1 and CB2, two input boxes IP1 and IP2, a list area LS1, five display areas DS1, DS2, DS3, DS4 and DS5, two button images BT1 and BT2.

The check box CB1 is checked when a delivery management target is a commodity. The check box CB2 is checked when the delivery management target is a folding type container (hereinafter referred to as a collapsible container). In the present embodiment, the description is made assuming that the delivery management target is the commodity as an example.

In the input box IP1, a commodity code is input when the delivery management target is a commodity, and a unique code attached to a collapsible container is input when the delivery management target is a collapsible container. A start date and time and an end date and time of a period are input as a delivery management period in the input box IP2.

The list area LS1 displays an individual list of commodities specified by the code input in the input box IP1 and the period input in the input box IP2. The individual list includes a commodity image, an identification number, and a commodity name (xxxxxx) of one or more individual commodities.

The display area DS1 displays the identification number of an individual commodity selected from the individual list. The display area DS2 displays an image of the individual commodity identified by the identification number displayed in the display area DS1, and delivery history information. The delivery history information includes time, location and status. In other words, information relating to when, where, and in what state the commodity corresponding to the image is, is displayed in chronological order. The display area DS3 displays a road map indicating a delivery route of the individual commodity selected from the individual list. Incidentally, in FIG. 13, a symbol of double circle indicates each of the manufacturer A, the distribution center B and the store C. A solid line connecting the two symbols of the double circles indicates a route of the transport devices T1 and T2. The display area DS4 displays a graph showing changes in temperature and humidity in the manufacturer A, the distribution center B, the store C or at an arbitrary place on the delivery route. The display area DS4 displays a graph showing changes in acceleration in the manufacturer A, the distribution center B, the store C or at an arbitrary place on the delivery route.

A retrieval button BT1 is a button image for instructing retrieval under conditions input to the input box IP1 and the input box IP2. A termination button B2 is a button image for instructing the termination of the delivery management.

In an initial state of the delivery monitoring screen SC1 with such a configuration, the check box CB1 and the check box CB2 are not checked. The input box IP1 and the input box IP2 are blank. The list area LS1 and the display area DS1 are also blank. All the other display areas DS2, DS3, DS4 and DS5 are not displayed.

The user operates the input device to input necessary data to the input box IP1 and the input box IP2 in the user terminal 60 on which the delivery monitoring screen SC1 in the initial state is displayed on the display device. For example, as shown in FIG. 13, the user checks the check box CB1 and inputs a commodity code “123456789” in the input box IP1. The user inputs the period start date and time “2017/06/01 12:00” and the period end date and time “2017/06/02 18:00” in the input box IP2. Then, the user operates the retrieval button BT1.

If the retrieval button BT1 is operated, a retrieval command is transmitted from the user terminal 60 to the first server 30 via the network 70. The retrieval command includes information indicating the check box CB1 or CB2 which is checked, the code input to the input box IP1, and information relating to the start and end of the period input to the input box IP2. The processor 31 of the first server 30 receiving the retrieval command executes a program to perform an information processing having procedures shown in the flowcharts in FIG. 10 to FIG. 12.

Specifically, the processor 31 stands by until the retrieval command is received in Act 1. Upon receiving the retrieval command via the communication interface 34 (Yes in Act 1), the processor 31 acquires information (code, period, etc.) contained in the retrieval command in Act 2.

The processor 31 determines whether or not the code and a retrieval period which are retrieval conditions are correctly acquired from the information contained in the retrieval command in Act 3. For example, when the code in the input box IP1 is not a commodity code (i.e., does not correspond to a commodity code system) despite that the check box CB1 is checked, the processor 31 determines that the retrieval condition is an error. For example, when the period start date and time is later than the period end date and time by comparing the period start date and time and the period end date and time, the processor 31 determines that the retrieval condition is an error.

If the retrieval condition is an error (No in Act 3), the processor 31 returns to the processing in Act 1. Then, the processor 31 stands by until a next retrieval command is received.

If the retrieval condition is correct (Yes in Act 3), the processor 31 accesses the tracking repository 41 stored in the second server 40, and sequentially reads the data record 41R in Act 4. Then, each time the data record 41R is read from the tracking repository 41, the processor 31 determines whether or not the data record 41R satisfies the retrieval condition in Act 5. For example, when the commodity code in the data record 41R matches the code which is the retrieval condition, and the date and time in the data record 41R is within the period which is the retrieval condition, the processor 31 determines that the data record 41R satisfies the retrieval condition. When the commodity code in the data record 41R does not match the code which is the retrieval condition or the date and time of the data record 41R is beyond the period which is the retrieval condition, the processor 31 determines that the data record 41R does not satisfy the retrieval condition. If the data record 41R does not satisfy the retrieval condition (No in Act 5), the processor 31 determines whether or not the retrieval in the tracking repository 41 is terminated in Act 6. If the retrieval in the tracking repository 41 is not terminated (No in Act 6), the processor 31 returns to the processing in Act 5, and determines whether or not the next data record 41R satisfies the retrieval condition.

If the data record 41R read from the tracking repository 41 satisfies the retrieval condition (Yes in Act 5), the processor 31 creates the integrated data 90R from the items of the data record 41R in Act 7. At this time, the processor 31 integrates the date and time, the commodity code and the identification number in the data record 41R, and the commodity name stored in association with the commodity code in the commodity master file 331 into the integrated data 90R. The processor 31 refers to the conversion table 80 to convert the terminal 1 ID in the data record 41R into the location ID set in association with the terminal 1 ID in the conversion table 80 in Act 8. Then, the processor 31 integrates the location ID and the location name stored in association with the location ID in the location master file 332 into the integrated data 90R. The processor 31 sets the type flag in the integrated data 90R to “0” in Act 9. Furthermore, the processor 31 sets the actual data in the integrated data 90R to the status contained in the data record 41R in Act 10. Thus, the processor 31 creates the first integrated data 90R1 from the data record 41R satisfying the retrieval condition.

If the processing in the above Act 7 to Act 10 is terminated, the processor 31 stores the integrated data 90R (first integrated data 90R1) in the integrated file 90 in Act 11. After that, the processor 31 returns to the processing in Act 5. In other words, the processor 31 continues retrieving data records 41R from the tracking repository 41. Every time the data record 41R that satisfies the retrieval condition is detected, the processor 31 repeatedly executes the processing in Act 7 to Act 11 in the same way as described above.

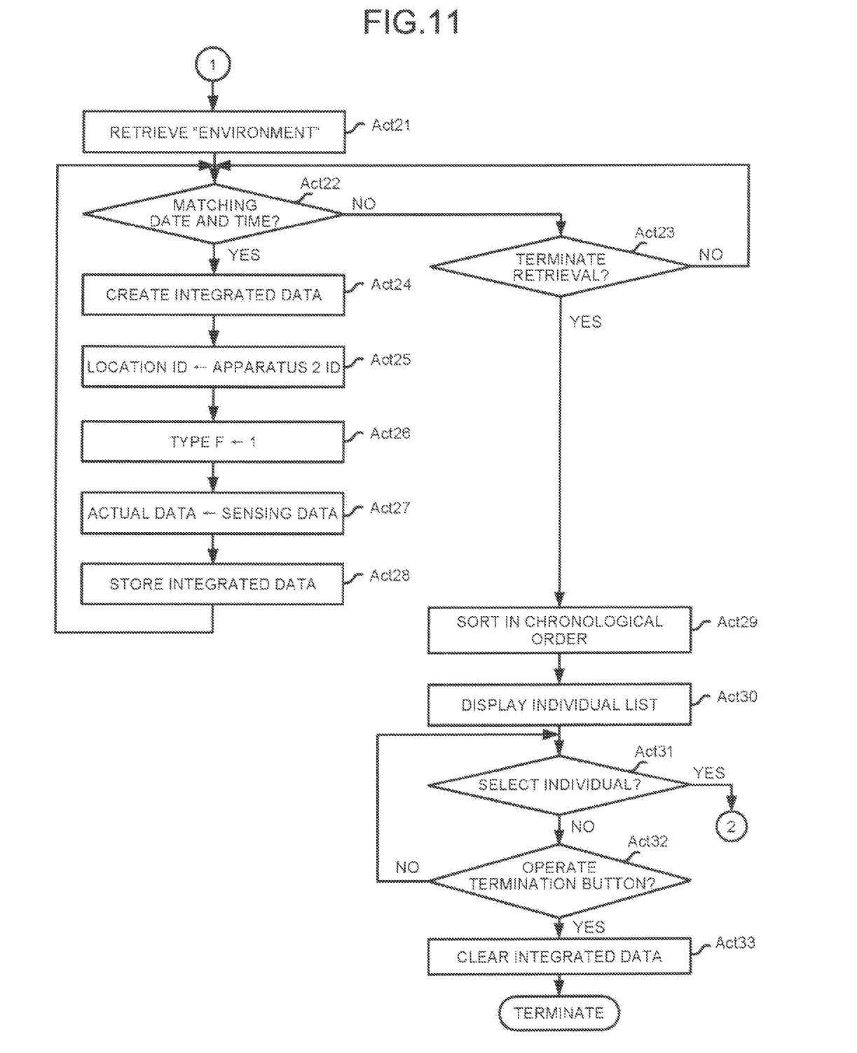

If the retrieval from the tracking repository 41 is terminated (Yes in Act 6), the processor 31 proceeds to the processing in Act 21 in FIG. 11. In Act 21, the processor 31 accesses the environment repository 51 stored in the third server 50, and sequentially reads the data record 51R. Then, each time the data record 51R is read from the environment repository 51, the processor 31 determines whether or not the date and time in the data record 51R matches the date and time which are the retrieval condition in Act 22. If the date and time in the data record 51R do not match the date and time which are the retrieval condition (No in Act 22), the processor 31 determines whether or not the retrieval in the environment repository 51 is completed in Act 23. If the retrieval in the environment repository 51 is not terminated (No in Act 23), the processor 31 returns to the processing in Act 22 and determines whether or not the date and time in the next data record 51R matches the date and time which are the retrieval condition.

If the date and time in the data record 51R read from the environment repository 51 matches the date and time which are the retrieval condition (Yes in Act 22), the processor 31 creates the integrated data 90R from the items in the data record 51R in Act 24. At this time, the processor 31 integrates the date and time in the data record 51R into the integrated data 90R. The processor 31 refers to the conversion table 80 to convert the terminal 2 ID in the data record 51R into the location ID set in association with the terminal 2 ID in the conversion table 80 in Act 25. Then, the processor 31 integrates the location ID and the location name stored in association with the location ID in the location master file 332 into the integrated data 90R. The processor 31 sets the type flag in the integrated data 90R to “1” in Act 26. Furthermore, the processor 31 sets the actual data in the integrated data 90R to the sensing data contained in the data record 51R in Act 27. Thus, the processor 31 creates the second integrated data 90R2 from the data record 51R whose date and time match the retrieval condition in the date and time.

If the processing in Act 24 to Act 27 described above is terminated, the processor 31 stores the integrated data 90R (second integrated data 90R2) in the integrated file 90 in Act 28. Thereafter, the processor 31 returns to the processing in Act 22. In other words, the processor 31 continues accessing the environment repository 51. Then, each time the data record 51R whose date and time match the retrieval condition is detected, the processor 31 repeatedly executes the processing in Act 24 to Act 28 in the same way as described above.

If the retrieval from the environment repository 51 is terminated (Yes in Act 23), the processor 31 sorts the integrated data 90R stored in the integrated file 90 in chronological order or in reverse chronological order in Act 29. As described above, in the integrated file 90, the first integrated data 90R1 created based on the data record 41R detected from the tracking repository 41 and the second integrated data 90R2 created based on the data record 51R detected from the environment repository 51 are stored. In the integrated file 90, the first integrated data 90R1 and the second integrated data 90R2 are sorted and stored in chronological order by the processing in Act 29.

The processor 31 creates an individual list from the integrated data 90R stored in the integrated file 90 in Act 30. Specifically, the processor 31 first detects the integrated data in which the type flag is “0”, i.e., the first integrated data 90R1 from the integrated file 90. Then, the processor 31 acquires the identification number and the commodity name from the first integrated data 90R1. The processor retrieves the commodity master file 331 with the commodity code in the first integrated data 90R1 to acquire the commodity image. Then, the processor 31 creates an individual list from the acquired identification number, commodity name and commodity image, and controls the user terminal 60 via the communication interface 34 such that the individual list is displayed in the list area LS1 of the delivery monitoring screen SC. Through the control, in the list area LS1 of the delivery monitoring screen SC, the individual list of commodities delivered within the period input in the input box IP2 is displayed among the commodities specified by the code input to the input box IP1.

Therefore, the user selects an individual commodity whose delivery status is required to be confirmed from the individual list. If the individual is not selected, the user operates the termination button BT2.

The processor 31 of the first server 30 confirms whether or not an individual commodity is selected with the user terminal 60 in Act 31. If no individual commodity is selected (No in Act 31), the processor 31 confirms whether or not the termination button BT2 is operated in Act 32. If the termination button BT2 is not operated (No in Act 32), the processor 31 returns to the processing in Act 31. Here, the processor 31 stands by until the individual commodity is selected in Act 31 or the termination button BT2 is operated in Act 32.

In the standby state in Act 31 and Act 32, if the termination button BT2 is operated (Yes in Act 32), the processor 31 clears the integrated data 90R in the integrated file 90 in Act 33. Thus, the processor 31 terminates the processing shown in the flowchart.

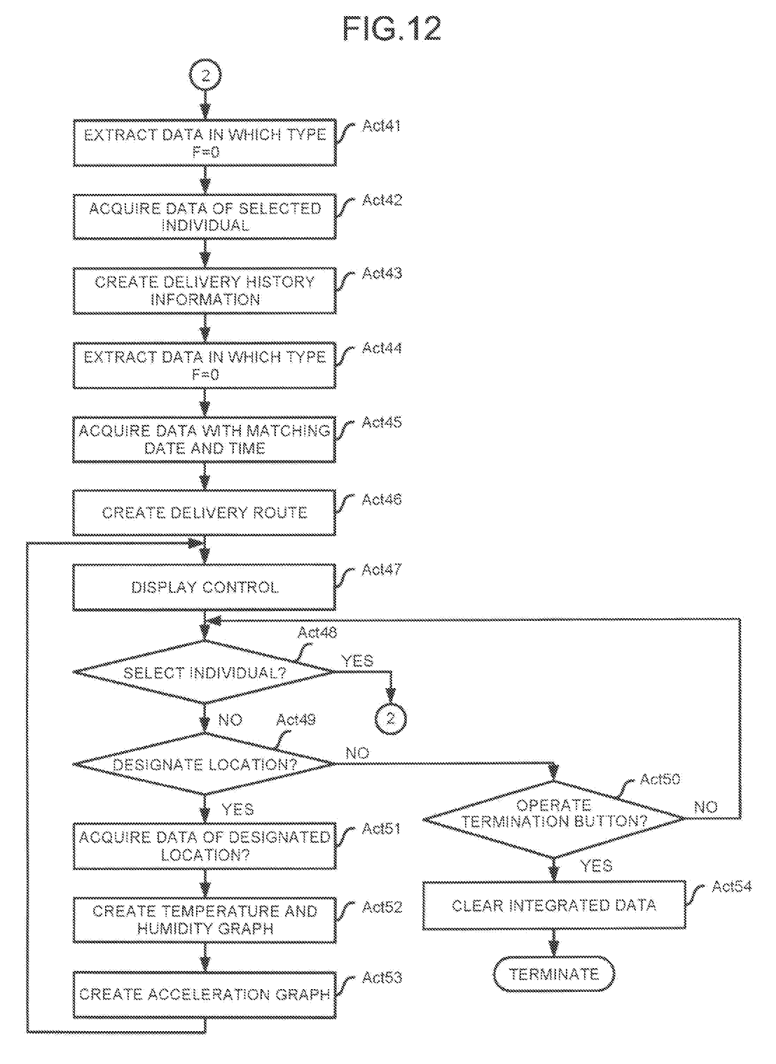

In the standby state in Act 31 and Act 32, if the individual commodity is selected (Yes in Act 31), the processor 31 proceeds to the processing in Act 41 in FIG. 12. In other words, the processor 31 extracts the integrated data 90R in which the type flag is “0”, i.e., the first integrated data 90R1 from the integrated file 90 in Act 41. Then, the processor 31 acquires the first integrated data 90R1 in which the identification number matches the selected identification number from the extracted first integrated data 90R1 in Act 42.

The processor 31 generates an image of the delivery history information in which the date and time, the location name and the status as the actual data in the first integrated data 90R1 acquired in Act 42 are arranged in the chronological order.

The processor 31 extracts data in which the type flag is “1”, i.e., the second integrated data 90R2 from the integrated file 90 in Act 44. Then, the processor 31 acquires the second integrated data 90R2 having the same date and time as the first integrated data 90R1 acquired in Act 42 from the second integrated data 90R2 extracted in Act 45.

The processor 31 creates the image indicating the delivery route based on position information of the sensing data which is the actual data in the second integrated data 90R2 acquired in Act 45, and the road map data stored in the map master file 333 in Act 46.

The processor 31 controls the user terminal 60 via the communication interface 34 so as to display the image of the delivery history information created in Act 43 and the image showing the delivery route created in Act 46 in the display area DC2 and the display area DC3 of the delivery monitoring screen SC in Act 47.

In this way, the user can confirm the delivery history information and the delivery route of the individual selected from the individual list. Here, if the user wants to confirm the delivery status of another individual commodity, the user selects the individual commodity from the individual list. Furthermore, when the user wants to confirm the environmental information of the individual commodity whose delivery history information and delivery route are confirmed, the user designates a predetermined locations on the map indicating the delivery route, such as double circles indicating locations or a solid line for connecting locations.

The processor 31 confirms whether or not the next individual commodity is selected in Act 48. If the individual commodity is not selected (No in Act 48), the processor 31 confirms whether or not the predetermined location on the map is designated in Act 49. If the predetermined location is not designated (No in Act 49), the processor 31 confirms whether or not the termination button BT2 is operated in Act 50. If the termination button BT2 is not operated (No in Act 50), the processor 31 returns to the processing in Act 48. Here, the processor 31 stands by until the individual commodity is selected in Act 48, the location is designated in Act 49 or the termination button BT2 is operated in Act 50.

If the individual commodity is selected in the standby state in Act 48 to Act 50 (Yes in Act 48), the processor 31 returns to the processing in Act 41, and executes the processing subsequent to Act 41 in the same way as described above.

In the standby state in Act 48 to Act 50, if the location is designated (Yes in Act 49), the processor 31 acquires a record corresponding to the designated location from the second integrated data 90R2 acquired in Act 45 in Act 51. Specifically, if the location is designated, the processor 31 acquires the second integrated data 90R2 including the location ID assigned to the location. If the solid line indicating the delivery route by the transport device T1 or T2 is designated, the processor acquires the second integrated data 90R2 including the location ID assigned to the transport device T1 or T2.

The processor 31 acquires the values of the temperature and the humidity in chronological order from the actual data in the second integrated data 90R2 acquired in Act 51 and creates a graph indicating changes in the temperature and the humidity from the acquired values. The processor 31 acquires the values of the acceleration in chronological order from the actual data in the same second integrated data 90R2 and creates a graph indicating the change in the acceleration from the acquired values. Then, the processor 31 returns to the processing in Act 47, and controls the user terminal 60 via the communication interface 34 so as to display the graph indicating the changes in the temperature and the humidity and the graph showing the changes in the acceleration in the display area DC4 and the display area DC5 of the delivery monitoring screen SC. After that, the processor 31 enters a standby state in Act 48 to Act 50.

In the standby state in Act 48 to Act 50, if the termination button BT2 is operated (Yes in Act 50), the processor 31 clears the integrated data 90R of the integrated file 90 in Act 54. Thus, the processor 31 terminates the processing shown in the flowchart.

The first server (delivery management apparatus) 30 operating as described above functions as an acquisition module by executing the processing in Act 4 to Act 11 in FIG. 10 and the processing in Act 21 to Act 28 in FIG. 11 under the control of the processor 31. Specifically, the first server 30 acquires first information (data record 41R) in which the information (status) relating to a state of the commodity detected by the first terminal 10 located in each storage location (location) of the commodity and the identification information (terminal 1 ID) of the first terminal are associated with each other from the tracking repository 41. The first server 30 acquires second information (data record 51R) in which the environmental information (sensing data) of the storage location detected by the second terminal 20 arranged for the same storage location (location) and the identification information (terminal 2 ID) of the second terminal 20 are associated with each other from the environment repository 51.

The first server 30 functions as a first creation module by executing the processing in Act 41 to Act 43 in FIG. 12 under the control of the processor 31. In other words, from the first information (data record 41R) acquired by the acquisition module, the first server 30 refers to the conversion table 80 to specify the storage location where the first terminal 10 identified by the identification information contained in the first information is arranged, and creates the image (delivery history information) indicating transition of the state of the commodity in the storage location.

The first server 30 functions as a second creation module by executing the processing in Act 51 to Act 53 in FIG. 12 under the control of the processor 31. Specifically, from the second information (data record 51R) acquired by the acquisition module, the first server 30 refers to the conversion table 80 to specify the storage location in which the first terminal 10 identified by the identification information contained in the second information is installed, and creates the image (temperature and humidity graph or acceleration graph) indicating the change in the environment of the storage location.

Furthermore, the first server 30 functions as an output module by executing the processing in Act 47 in FIG. 12 under the control of the processor 31. Specifically, the first server 30 performs control so as to display the delivery monitoring screen SC1 obtained by integrating the image created by the first creation module and the image created by the second creation module on the display device of the user terminal 60.

Therefore, according to the present embodiment, it is possible to integrate the delivery history of the commodity with the change in the temperature and the humidity of the environment in which the commodity is placed or the change in the acceleration, and allow the user to browse the integrated information by the delivery monitoring screen SC1 displayed on the display device of the user terminal 60.

Meanwhile, the second terminal 20 is also provided in the transport devices T1 and T2 for transporting the commodity from one location to another. Then, the second creation module of the first server 30 specifies not only the storage location but also the transport device as the location where the second terminal 20 identified by the identification information contained in the second information from the second information acquired by the acquisition module to create the image indicating the change in the environment of each location.

Therefore, according to the present embodiment, there is an advantage that the changes in the temperature and humidity of the environment in which the commodity being delivered is placed and the change in the acceleration can be integrated and can be browsed by the delivery monitoring screen SC1.

The second terminal 20 includes the GPS sensor 23, and can further detect the position information of the second terminal 20. Then, the first server 30 functions as a third creation module by executing the processing in Act 44 to Act 46 in FIG. 12 under the control of the processor 31. Specifically, the first server 30 creates the image indicating the movement (delivery route) of the commodity from the position information of the second terminal 20 identified by the identification information contained in the second information. Then, the output module of the first server 30 performs control so as to display the delivery monitoring screen SC1 obtained by integrating the image created by the first creation module and the image created by the second creation module with the image created by the third creation module on the display device of the user terminal 60.

Therefore, according to the present embodiment, it is possible to integrate the delivery route of the commodity and allow the user to browse the integrated information by the delivery monitoring screen SC1 displayed on the display device of the user terminal 60.

The first server 30 functions as a designation module by executing the processing in Act 1 to Act 3 in FIG. 10 under the control of the processor 31. Specifically, the first server 30 recognizes that the period is designated from the information input to the input box IP2 on the delivery monitoring screen SC1. Then, the acquisition module of the first server 30 acquires the first information obtained by associating the information relating to the state of the commodity detected by the first terminal 10 within the designated period with the identification information of the first terminal 10, and the second information obtained by associating the environmental information of the storage location detected by the second terminal 20 with the identification information of the second terminal 20.

Therefore, according to the present embodiment, within the arbitrarily designated period, the delivery history of the commodity and the environment where the commodity is located can be integrated and can be browsed.

Below, the modification of the embodiment is described.

In the above embodiment, the output module performs control so as to display the delivery monitoring screen SC1 in which the image created by the first creation module and the image created by the second creation module are integrated with each other on the display device of the user terminal 60. However, the output module is not limited thereto. For example, the output module may perform control so as to print an image obtained by integrating the image created by the first creation module with the image created by the second creation module with a printer to output the image.

In the above embodiment, the temperature sensor 25 and the humidity sensor 26 are provided in the second terminal 20. At least one of the temperature sensor 25 and the humidity sensor 26 may be provided outside the second terminal 20, and the controller 21 of the second terminal 20 may read information from the external sensor. In the above embodiment, the temperature and the humidity are taken as the environmental information (sensing data) collected during storage and transportation of the fresh commodity; however, the environmental information is not limited to those specifically described above. That is, the type of the environmental information is not limited as long as the information, which can be collected during storage and transportation of the fresh commodity, changes depending on a freshness of a fresh commodity, such as odor, or affects the freshness of the fresh commodity, such as vibration, acceleration, illuminance, etc.

In the above embodiment, the first server 30, the second server 40, and the third server 50 are described as server devices on the cloud D. Each of the servers 30, 40 and 50 is not necessarily provided on the cloud D as long as it is connected to the network 70. The functions of at least two servers may be integrated in one server.

In the above embodiment, an example in which the RFID tag is attached to the commodity is shown, but an example in which a barcode is attached to the commodity may be used. In this case, the reader 14 of the first terminal 10 is a barcode scanner. In addition, the article is not limited to the commodity.

The installation of the first server 30 which functions as the delivery management apparatus is generally performed in a state in which the program is stored in the main memory 32 or the auxiliary storage device 33. However, the present invention is not limited as described above. For example, the installation may be performed in a state in which the program is not stored in the main memory 32 or the auxiliary storage device 33. In this case, the program transferred independent of the first server 30 may be written into a writable storage device of the first server 30 in response to an operation of the user or the like. The transfer of the program can be performed by recording it in a removable recording medium or by communication via the network. The form of the storage medium is not limited as long as it can store the program and can be read by the apparatus such as a CD-ROM, a memory card, etc. A function obtained by installing or downloading the program may be realized in cooperation with an OS (Operating System) or the like in the apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A delivery management system comprising a first terminal, a second terminal, and at least one server programmed to:
receive from a user device a retrieval request including: a commodity code corresponding to commodities subject to a delivery process, and a retrieval condition;
based on the retrieval request, for each individual commodity that corresponds to the commodity code included in the retrieval request and whose status in the delivery process correspond to the retrieval condition, acquire:
first information including, in correspondence, location status information indicating a delivery status of the individual commodity detected by the first terminal, and first location information corresponding to a location of the first terminal, and
second information, including, in correspondence, environmental information indicating at least one environmental condition detected by the second terminal at a storage location of the individual commodity, and second location information corresponding to a location of the second terminal;
generate and output to the user device display information for causing the user device to display a list of each individual commodity that corresponds to the commodity code included in the retrieval request and whose status in the delivery process correspond to the retrieval condition;
receive from the user device a first selection of one of the individual commodities displayed on the list, and in response, generate and output to the user device delivery route information causing the user device to display a delivery route map indicating a delivery route of the selected individual commodity based on the first information; and
receive from the user device a second selection of a portion of the delivery route, and in response, generate and output to the user device environmental information causing the user device to display the at least one environmental condition at a location corresponding to the selected portion of the delivery route based on the second information.

2. The delivery management system according to claim 1, wherein
the second terminal is provided in a transport device that delivers the individual commodity from one storage location to another storage location, and
the delivery route map includes a delivery path of the transport device.

3. The delivery management system according to claim 2, wherein, when the second selection corresponds to the delivery path of the transport device, the environmental information causes the user device to display an image indicating changes in the at least one environmental condition of the transport device along the delivery path.

4. The delivery management system according to claim 1, wherein the display information, the delivery route information and the environmental information cause the user device to display the list, the delivery route map, and the at least one environmental condition together as an integrated image.

5. The delivery management system according to claim 1, wherein the retrieval condition is a time period.

6. The delivery management system according to claim 1, wherein the at least one environmental condition includes temperature and humidity information.

7. The delivery management system according to claim 1, wherein the at least one environmental condition includes acceleration information.

8. A delivery management server comprising a processor programmed to:
receive from a user device a retrieval request including: a commodity code corresponding to commodities subject to a delivery process, and a retrieval condition;
based on the retrieval request, for each individual commodity that corresponds to the commodity code included in the retrieval request and whose status in the delivery process correspond to the retrieval condition, acquire:
first information including, in correspondence, location status information indicating a delivery status of the individual commodity detected by a first terminal, and first location information corresponding to a location of the first terminal, and
second information, including, in correspondence, environmental information indicating at least one environmental condition detected by a second terminal at a storage location of the individual commodity, and second location information corresponding to a location of the second terminal;
generate and output to the user device display information for causing the user device to display a list of each individual commodity that corresponds to the commodity code included in the retrieval request and whose status in the delivery process correspond to the retrieval condition;
receive from the user device a first selection of one of the individual commodities displayed on the list, and in response, generate and output to the user device delivery route information causing the user device to display a delivery route map indicating a delivery route of the selected individual commodity based on the first information; and
receive from the user device a second selection of a portion of the delivery route, and in response, generate and output to the user device environmental information causing the user device to display the at least one environmental condition at a location corresponding to the selected portion of the delivery route based on the second information.

9. The delivery management server according to claim 8, wherein
the second terminal is provided in a transport device that delivers the individual commodity from one storage location to another storage location, and
the delivery route map includes a delivery path of the transport device.

10. The delivery management server according to claim 9, wherein, when the second selection corresponds to the delivery path of the transport device, the environmental information causes the user device to display an image indicating changes in the at least one environmental condition of the transport device along the delivery path.

11. The delivery management server according to claim 8, wherein the display information, the delivery route information and the environmental information cause the user device to display the list, the delivery route map, and the at least one environmental condition together as an integrated image.

12. The delivery management server according to claim 8, wherein the retrieval condition is a time period.

13. The delivery management server according to claim 8, wherein the at least one environmental condition includes temperature and humidity information.

14. The delivery management server according to claim 8, wherein the at least one environmental condition includes acceleration information.

15. A delivery management method comprising:
receiving from a user device a retrieval request including: a commodity code corresponding to commodities subject to a delivery process, and a retrieval condition;
based on the retrieval request, for each individual commodity that corresponds to the commodity code included in the retrieval request and whose status in the delivery process correspond to the retrieval condition, acquiring:
first information including, in correspondence, location status information indicating a delivery status of the individual commodity detected by a first terminal, and first location information corresponding to a location of the first terminal, and
second information, including, in correspondence, environmental information indicating at least one environmental condition detected by a second terminal at a storage location of the individual commodity, and second location information corresponding to a location of the second terminal;
generating and outputting to the user device display information for causing the user device to display a list of each individual commodity that corresponds to the commodity code included in the retrieval request and whose status in the delivery process correspond to the retrieval condition;
receiving from the user device a first selection of one of the individual commodities displayed on the list, and in response, generating and outputting to the user device delivery route information causing the user device to display a delivery route map indicating a delivery route of the selected individual commodity based on the first information; and
receiving from the user device a second selection of a portion of the delivery route, and in response, generating and outputting to the user device environmental information causing the user device to display the at least one environmental condition at a location corresponding to the selected portion of the delivery route based on the second information.

16. The delivery management method according to claim 15, wherein
the second terminal is provided in a transport device that delivers the individual commodity from one storage location to another storage location, and
the delivery route map includes a delivery path of the transport device.

17. The delivery management method according to claim 16, wherein, when the second selection corresponds to the delivery path of the transport device, the environmental information causes the user device to display an image indicating changes in the at least one environmental condition of the transport device along the delivery path.

18. The delivery management method according to claim 15, wherein the display information, the delivery route information and the environmental information cause the user device to display the list, the delivery route map, and the at least one environmental condition together as an integrated image.

19. The delivery management method according to claim 15, wherein the retrieval condition is a time period.

20. The delivery management method according to claim 15, wherein the at least one environmental condition includes acceleration information.
